(19) United States
(12) Patent Application Publication
(10) Pub. No.: US 2025/0210773 A1
(43) Pub. Date: Jun. 26, 2025

(54) JOINING STRUCTURE OF BATTERY PACK

(71) Applicant: TOYOTA JIDOSHA KABUSHIKI KAISHA, Toyota-shi (JP)

(72) Inventors: Mitsuaki NEGITA, Chiryu-shi (JP); Daiki KAWACHINO, Miyoshi-shi (JP); Yasuhito NAKAMURA, Nagoya-shi (JP); Takeshi MIZUTANI, Toyota-shi (JP); Yosuke ANDO, Okazaki-shi (JP); Hidenori HATTORI, Toyota-shi (JP); Nobuyasu NISHIKI, Toyokawa-shi (JP)

(73) Assignee: TOYOTA JIDOSHA KABUSHIKI KAISHA, Toyota-shi (JP)

(21) Appl. No.: 18/894,245

(22) Filed: Sep. 24, 2024

(30) Foreign Application Priority Data
Dec. 20, 2023 (JP) 2023-215007

(51) Int. Cl. H01M 50/242; B60K 1/04; H01M 50/249; H01M 50/264

(52) U.S. Cl. CPC H01M 50/242; B60K 1/04; H01M 50/249; H01M 50/264; B60K 2001/0438

(57) ABSTRACT

A joining structure of a battery pack according to one form of the present disclosure includes: a bracket to which a side end portion on either left or right of the battery pack is joined; and a joining member that joins an upper end portion of the bracket and the floor panel to each other. The joining member includes: an inclined portion that joins the bracket and the floor panel to each other and heads toward the upper side as the inner side of the vehicle is approached; and a fragile portion that is disposed in a lower end portion of the inclined portion and has a rigidity about an axis that extends in the front-rear direction of the vehicle that is lower than the rigidity of the center tunnel about the axis that extends in the front-rear direction of the vehicle.

### CROSS-REFERENCE TO RELATED APPLICATION

This application claims priority to Japanese Patent Application No. 2023-215007 filed on Dec. 20, 2023, incorporated herein by reference in its entirety.

### BACKGROUND

### 1. Technical Field

The present disclosure relates to a joining structure of a battery pack and relates to a joining structure that joins a battery pack disposed on the lower side of a floor panel having a center tunnel that extends in the front-rear direction of a vehicle to the floor panel, for example.

### 2. Description of Related Art

In general, when a battery pack is mounted on a vehicle, the battery pack is joined to a floor panel of the vehicle in a state of being disposed on the lower side of the floor panel. For example, in Japanese Unexamined Patent Application Publication No. 2022-111787, a battery pack is joined to a floor panel via a side frame that is an energy absorption (EA) material.

### SUMMARY

The applicants of the present disclosure have found the following problem. In a general floor panel, a center tunnel for causing brake pipes and the like to pass therethrough is formed to extend in the front-rear direction of a vehicle. Regarding such a center tunnel, a so-called fall down of the center tunnel may occur and the center tunnel may be pressed down to the lower side at the time of a side collision of the vehicle.

The present disclosure has been made in view of the problem as above and realizes a joining structure of a battery pack that is able to reduce a case in which a center tunnel of a floor panel is pressed down to the lower side at the time of a side collision of a vehicle.

A joining structure of a battery pack according to one aspect of the present disclosure is a joining structure that joins a battery pack disposed on the lower side of a floor panel having a center tunnel that extends in the front-rear direction of a vehicle to the floor panel, the joining structure including: a bracket to which a side end portion on either left or right of the battery pack is joined; and a joining member that joins an upper end portion of the bracket and the floor panel to each other. In the joining structure, the joining member includes: an inclined portion that joins the bracket and the floor panel to each other and heads toward the upper side as the inner side of the vehicle is approached; and a fragile portion that is disposed in a lower end portion of the inclined portion and has a rigidity about an axis that extends in the front-rear direction of the vehicle that is lower than the rigidity of the center tunnel about the axis that extends in the front-rear direction of the vehicle.

In the joining structure of the battery pack described above, the rigidity of the bracket about the axis that extends in the front-rear direction of the vehicle may be higher than the rigidity of the fragile portion of the joining member about the axis that extends in the front-rear direction of the vehicle.

The joining structure of the battery pack described above may include a reinforcing member that joins the side end portion of the battery pack and the bracket to each other. In the joining structure, the rigidity of the reinforcing member about the axis that extends in the front-rear direction of the vehicle may be higher than the rigidity of the bracket about the axis that extends in the front-rear direction of the vehicle and the rigidity of the center tunnel about the axis that extends in the front-rear direction of the vehicle.

In the joining structure of the battery pack described above, a gap portion for preventing contact between the battery pack and the bracket at the time of a side collision of the vehicle may be provided between the battery pack and the bracket in the left-right direction of the vehicle.

In the joining structure of the battery pack described above, the rigidity of the fragile portion of the joining member about the axis that extends in the front-rear direction of the vehicle may be lower than the rigidity of a center tunnel reinforcement provided in the center tunnel about the axis that extends in the front-rear direction of the vehicle, and the rigidity about the axis that extends in the front-rear direction of the vehicle may be higher in the order of the reinforcing member, the bracket, the center tunnel reinforcement, and the fragile portion of the joining member.

According to the present disclosure, it becomes possible to realize the joining structure of the battery pack that is able to reduce the case in which the center tunnel of the floor panel is pressed down to the lower side at the time of a side collision of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a joining structure of a battery pack of an embodiment;

FIG. 2 is a perspective view showing a reinforcing member, brackets, and a joining member in the joining structure of the battery pack of the embodiment; and

FIG. 3 is a view for describing a deformation when a vehicle suffers a side collision from the X-axis−side in the joining structure of the embodiment.

### DETAILED DESCRIPTION OF EMBODIMENTS

A specific embodiment to which the present disclosure is applied is described in detail below with reference to the drawings. However, the present disclosure is not limited to the embodiment below. The wordings and the drawings below are simplified, as appropriate, in order to clarify the description.

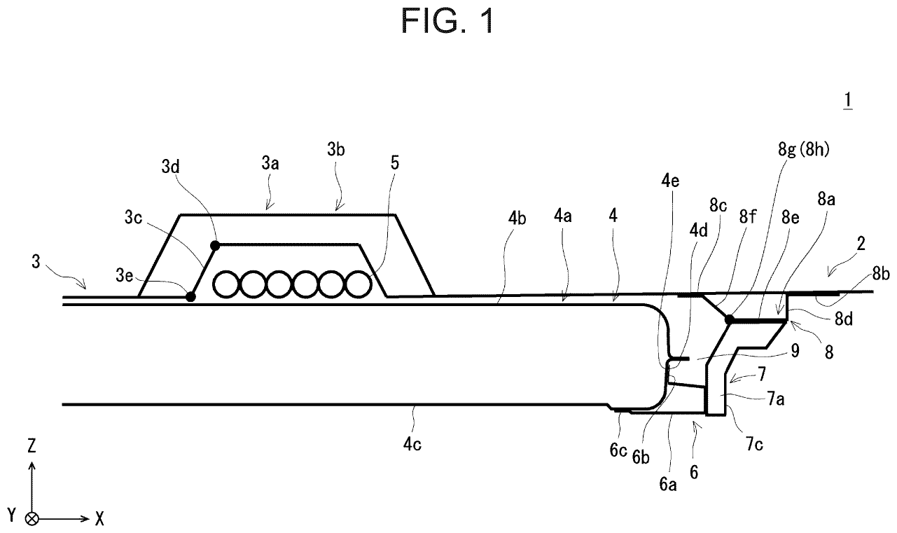

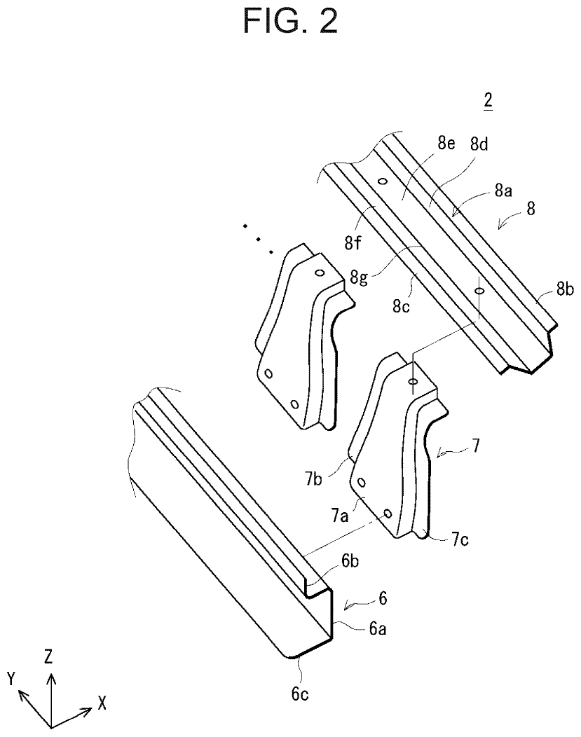

FIG. 1 is a schematic view showing a joining structure of a battery pack of the present embodiment. FIG. 2 is a perspective view showing a reinforcing member, brackets, and a joining member in the joining structure of the battery pack of the present embodiment. Here, in the description below, description is made with use of a three-dimensional (XYZ) coordinate system in order to clarify the description.

At this time, the X-axis+side is the right side of the vehicle, the X-axis−side is the left side of the vehicle, the Y-axis+side is the front side of the vehicle, the Y-axis−side is the rear side of the vehicle, the Z-axis+side is the upper side of the vehicle, and the Z-axis−side is the lower side of the vehicle.

As shown in FIG. 1, for example, a joining structure (may be hereinafter simply abbreviated to a joining structure) 1 of the battery pack of the present embodiment is suitable when an end portion on the X-axis+side or an end portion on the X-axis−side of a battery pack 4 disposed on the Z-axis−side with respect to a floor panel 3 of a vehicle 2 is joined to the floor panel 3. Therefore, a structure of joining the end portion on the Y-axis+side and the end portion on the Y-axis−side of the battery pack 4 to the floor panel 3 is not an essential part of the present disclosure, and hence description is omitted.

The joining structure 1 of the present embodiment has a line-symmetric configuration of which axis of symmetry is an axis that passes through the center of the vehicle 2 in the X-axis direction and is parallel to the Z-axis when seen from the Y-axis direction, for example. Therefore, a configuration on the X-axis+side is representatively described, and only a part on the X-axis+side of the vehicle 2 is representatively shown in FIG. 1.

Here, configurations of the floor panel 3 and the battery pack 4 are simply described first. As shown in FIG. 1, for example, the floor panel 3 includes a center tunnel 3a for accommodating brake pipes 5 and the like. The center tunnel 3a has a substantially isosceles trapezoid shape of which the Z-axis−side is opened when seen from the Y-axis direction and extends in the Y-axis direction in the substantially center of the floor panel 3 in the X-axis direction, for example.

The center tunnel 3a may be reinforced by a center tunnel reinforcement 3b as shown in FIG. 1, for example. The center tunnel reinforcement 3b is a rib member that has a substantially inverted hat-like shape in cross-section and that extends in the X-axis direction, for example. The center tunnel reinforcement 3b is fixed to an end portion on the Z-axis−side of the center tunnel 3a by being spaced apart from the end portion by a predetermined interval in the Y-axis direction.

The battery pack 4 is a secondary battery such as a lithium ion battery, and a plurality of battery cells is accommodated in a case 4a, for example. As shown in FIG. 1, for example, the case 4a includes an upper case 4b and a lower case 4c and is substantially hermetically sealed as a result of a flange portion 4d of the upper case 4b and a flange portion 4e of the lower case 4c being joined to each other.

Next, a configuration of the joining structure 1 of the present embodiment is described. As shown in FIG. 1 and FIG. 2, the joining structure 1 includes a reinforcing member 6, brackets 7, and a joining member 8. The reinforcing member 6 includes a bending portion 6a, a first flange portion 6b, and a second flange portion 6c and is a long member that extends in the Y-axis direction, for example.

As shown in FIG. 1 and FIG. 2, for example, the bending portion 6a has a substantially inverted C-shape of which X-axis−side is opened when seen from the Y-axis direction. The width dimension of the bending portion 6a in the X-axis direction is wider than the width dimension of the flange portion 4d of the upper case 4b and the flange portion 4e of the lower case 4c in the case 4a of the battery pack 4 in the X-axis direction.

As shown in FIG. 1 and FIG. 2, for example, the first flange portion 6b protrudes to the Z-axis+side from an open end portion of the bending portion 6a on the Z-axis+side. The second flange portion 6c protrudes to the X-axis−side from an open end portion of the bending portion 6a on the Z-axis−side, for example.

As shown in FIG. 1, the reinforcing member 6 is fixed to the battery pack 4 as a result of the first flange portion 6b being fixed to a side surface on the X-axis+side of the lower case 4c in the case 4a of the battery pack 4 and the second flange portion 6c being fixed to a bottom surface on the Z-axis−side of the lower case 4c in the case 4a of the battery pack 4.

At this time, as shown in FIG. 1, an end portion on the X-axis+side of the reinforcing member 6 is disposed on the X-axis+side with respect to end portions on the X-axis+side of the flange portion 4d of the upper case 4b and the flange portion 4e of the lower case 4c in the case 4a of the battery pack 4.

Here, it is preferred that the bending rigidity of the reinforcing member 6 about the Y-axis be higher than the bending rigidity of the center tunnel reinforcement 3b in the floor panel 3 about the Y-axis (for example, the bending rigidity of an end portion 3d on the Z-axis+side of an inclined portion 3c on the X-axis−side of the center tunnel reinforcement 3b about the Y-axis).

As shown in FIG. 2, for example, each of the brackets 7 has a substantially hat-like shape in cross-section and has a substantially inverted L-shape that bends to the Z-axis−side after extending to the X-axis−side when seen from the Y-axis direction. In other words, the bracket 7 has a shape in which a substantially hat-like shape in cross-section of which Z-axis−side is opened continues to the X-axis−side and then a substantially hat-like shape in cross-section of which X-axis+side is opened continues to the Z-axis−side. The bracket 7 includes a bending portion 7a, a first flange portion 7b, and a second flange portion 7c.

As shown in FIG. 2, the bending portion 7a has a substantially C-shape in cross-section and it is preferred that the width dimension of a part of the bending portion 7a that extends to the Z-axis−side in the Y-axis direction be widened toward the Z-axis−side, for example. The first flange portion 7b protrudes to the Y-axis+side from an open end portion on the Y-axis+side of the bending portion 7a. The second flange portion 7c protrudes to the Y-axis−side from an open end portion on the Y-axis−side of the bending portion 7a.

As shown in FIG. 2, the brackets 7 are disposed by a plurality of numbers to be spaced apart from each other at a predetermined interval in the Y-axis direction. As shown in FIG. 1, the bracket 7 is fixed to the battery pack 4 via the reinforcing member 6 as a result of a part of the bending portion 7a that extends in the Z-axis−side being joined to an end portion on the X-axis+side of the bending portion 6a of the reinforcing member 6.

At this time, a gap portion 9 is formed between the end portions on the X-axis+side of the flange portion 4d of the upper case 4b and the flange portion 4e of the lower case 4c in the case 4a of the battery pack 4 and the bending portion 7a of the bracket 7 in the X-axis direction as shown in FIG. 1 such that the battery pack 4 does not come into contact with the bracket 7 when the reinforcing member 6 is damaged at the time of a side collision of the vehicle 2.

Here, it is preferred that the bending rigidity of the bracket 7 about the Y-axis be higher than the bending rigidity of the center tunnel reinforcement 3b in the floor panel 3 (for example, the bending rigidity of the end portion 3d on the Z-axis+side of the inclined portion 3c on the X-axis−side of the center tunnel reinforcement 3b about the Y-axis) and lower than the bending rigidity of the reinforcing member 6 about the Y-axis.

As shown in FIG. 1 and FIG. 2, for example, the joining member 8 has a substantially inverted hat-like shape in cross-section of which Z-axis+side is opened when seen from the Y-axis direction and is a long member that extends in the Y-axis direction. The joining member 8 includes a bending portion 8a, a first flange portion 8b, and a second flange portion 8c.

As shown in FIG. 1 and FIG. 2, for example, the bending portion 8a has a substantially right trapezoid shape of which Z-axis+side is opened when seen from the Y-axis direction. In detail, the bending portion 8a includes a first portion 8d, a second portion 8e, and a third portion 8f.

As shown in FIG. 1 and FIG. 2, for example, the first portion 8d is disposed to be substantially parallel to a YZ plane. The second portion 8e extends to the X-axis-side from an end portion on the Z-axis−side of the first portion 8d and is disposed to be substantially parallel to an XY plane. The third portion 8f extends to the X-axis−side from an end portion on the X-axis−side of the second portion 8e and is inclined toward the Z-axis+side as the X-axis−side is approached.

As shown in FIG. 1 and FIG. 2, the first flange portion 8b protrudes to the X-axis+side from an open end portion on the X-axis+side of the bending portion 8a. The second flange portion 8c protrudes to the X-axis−side from an open end portion on the X-axis−side of the bending portion 8a.

As shown in FIG. 1 and FIG. 2, the joining member 8 joins the battery pack 4 to the floor panel 3 via the reinforcing member 6 and the brackets 7 as a result of joining the first flange portion 8b and the second flange portion 8c to an end portion on the Z-axis-side of the floor panel 3 and joining parts of the brackets 7 that extend to the X-axis−side of the bending portions 7a to the second portion 8e of the bending portion 8a. Therefore, the third portion 8f of the bending portion 8a in the joining member 8 joins the brackets 7 and the floor panel 3 to each other.

At this time, although detailed functions are described below, an end portion 8g on the Z-axis−side of the third portion 8f of the bending portion 8a in the joining member 8 forms a fragile portion 8h of which bending rigidity about the Y-axis is lower than the bending rigidity of the center tunnel reinforcement 3b in the floor panel 3 (for example, the bending rigidity of the end portion 3d on the Z-axis+side of the inclined portion 3c on the X-axis−side of the center tunnel reinforcement 3b about the Y-axis).

Here, it is preferred that the bending rigidity of the fragile portion 8h of the joining member 8 about the Y-axis be lower than the bending rigidity of the reinforcing member 6 about the Y-axis and the bending rigidity of the brackets 7 about the Y-axis. As a result, it is preferred that the bending rigidity about the Y-axis be higher in the order of the reinforcing member 6, the brackets 7, the center tunnel reinforcement 3b of the floor panel 3, and the fragile portion 8h of the joining member 8.

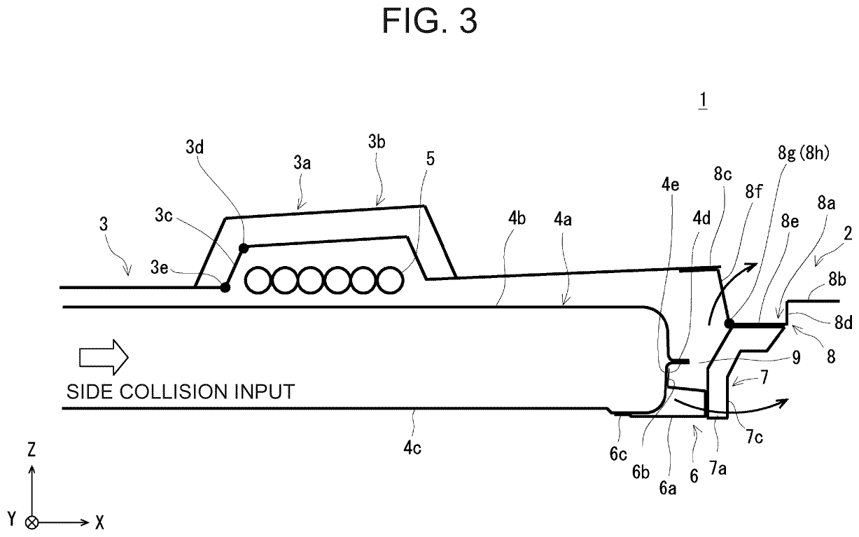

Next, a deformation when the vehicle 2 suffers a side collision from the X-axis−side in the joining structure 1 of the present embodiment is described. FIG. 3 is a view for describing a deformation when the vehicle suffers a side collision from the X-axis−side in the joining structure of the present embodiment. In FIG. 3, a part of the floor panel 3 on the X-axis+side with respect to the second flange portion 8c of the joining member 8 is omitted.

In a general vehicle, when the vehicle suffers a side collision from the X-axis−side and the floor panel 3 is deformed to the X-axis+side, the inclined portion 3c rotates in a counterclockwise manner about the end portion 3d on the Z-axis+side of the inclined portion 3c on the X-axis−side that is the side of the center tunnel reinforcement 3b of the floor panel 3 that has suffered the side collision when seen from the Y-axis−side.

As a result, an end portion 3e on the Z-axis−side of the inclined portion 3c on the X-axis−side of the center tunnel reinforcement 3b in the floor panel 3 is pressed down to the Z-axis−side, and hence there has been a need to secure a large space between the floor panel 3 and the battery pack 4 such that the end portion on the Z-axis−side 3e of the inclined portion 3c does not come into contact with the battery pack 4.

Meanwhile, the joining structure 1 of the present embodiment is configured such that the fragile portion 8h of the joining member 8 has a lower bending rigidity about the Y-axis than the bending rigidity of the end portion 3d on the Z-axis+side of the inclined portion 3c on the X-axis−side of the center tunnel reinforcement 3b in the floor panel 3 about the Y-axis, for example.

Therefore, as shown in FIG. 3, the fragile portion 8h of the joining member 8 is deformed in accordance with the deformation of the floor panel 3 to the X-axis+side before the end portion 3d on the Z-axis+side of the inclined portion 3c on the X-axis−side of the center tunnel reinforcement 3b in the floor panel 3 is deformed, and the third portion 8f of the bending portion 8a in the joining member 8 rotates in a clockwise manner about the fragile portion 8h when seen from the Y-axis−side.

As a result, as shown in FIG. 3, the third portion 8f of the bending portion 8a of the joining member 8 presses up the floor panel 3 to the Z-axis+side. Therefore, a case in which the center tunnel 3a of the floor panel 3 is pressed down to the Z-axis−side can be reduced. As a result, when the joining structure 1 of the present embodiment is employed, the battery pack 4 can be disposed to be closer to the floor panel 3 and the minimum ground height can be caused to be higher as compared to a general vehicle, for example.

Here, when the vehicle 2 suffers a side collision from the X-axis−side, as shown in FIG. 3, the brackets 7 are pressed by the battery pack 4 and the reinforcing member 6 and rotate in a counterclockwise manner when seen from the Y-axis−side. However, when the bending rigidity about the Y-axis is higher in the order of the reinforcing member 6, the brackets 7, the center tunnel reinforcement 3b of the floor panel 3, and the fragile portion 8h of the joining member 8 as described above, a case in which the reinforcing member 6 and the brackets 7 are greatly deformed before the joining member 8 and the center tunnel reinforcement 3b of the floor panel 3 are deformed can be reduced.

Therefore, for example, a state in which the reinforcing member 6 and the brackets 7 are greatly deformed before the joining member 8 and the center tunnel reinforcement 3b of the floor panel 3 are deformed, the fragile portion 8h of the joining member 8 is deformed to the Z-axis−side, and the floor panel 3 cannot be sufficiently pressed up to the Z-axis+side as a result can be avoided.

As above, the joining structure 1 of the present embodiment is configured such that the fragile portion 8h of the joining member 8 has a lower bending rigidity about the Y-axis than the bending rigidity of the end portion 3d on the Z-axis+side of the inclined portion 3c on the X-axis−side of the center tunnel reinforcement 3b in the floor panel 3 about the Y-axis, for example.

Therefore, as shown in FIG. 3, the fragile portion 8h of the joining member 8 is deformed in accordance with the deformation of the floor panel 3 to the X-axis+side before the end portion 3d on the Z-axis+side of the inclined portion 3c on the X-axis−side of the center tunnel reinforcement 3b in the floor panel 3 is deformed, and the third portion 8f of the bending portion 8a in the joining member 8 rotates in a clockwise manner about the fragile portion 8h when seen from the Y-axis−side.

As a result, as shown in FIG. 3, the third portion 8f of the bending portion 8a of the joining member 8 presses up the floor panel 3 to the Z-axis+side. Therefore, a case in which the center tunnel 3a of the floor panel 3 is pressed down to the Z-axis−side can be reduced. As a result, when the joining structure 1 of the present embodiment is employed, the battery pack 4 can be disposed to be closer to the floor panel 3 and the minimum ground height can be caused to be higher as compared to a general vehicle, for example.

When the vehicle 2 suffers a side collision from the X-axis−side, as shown in FIG. 3, the brackets 7 are pressed by the battery pack 4 and the reinforcing member 6 and rotate in a counterclockwise manner when seen from the Y-axis−side. However, when the bending rigidity about the Y-axis is higher in the order of the reinforcing member 6, the brackets 7, the center tunnel reinforcement 3b of the floor panel 3, and the fragile portion 8h of the joining member 8 as described above, a case in which the reinforcing member 6 and the brackets 7 are greatly deformed before the joining member 8 and the center tunnel reinforcement 3b of the floor panel 3 are deformed can be reduced.

Therefore, for example, a state in which the reinforcing member 6 and the brackets 7 are greatly deformed before the joining member 8 and the center tunnel reinforcement 3b of the floor panel 3 are deformed, the fragile portion 8h of the joining member 8 is deformed to the Z-axis−side, and the floor panel 3 cannot be sufficiently pressed up to the Z-axis+side as a result can be avoided.

The gap portion 9 is formed between the end portions on the X-axis+side of the flange portion 4d of the upper case 4b and the flange portion 4e of the lower case 4c in the case 4a of the battery pack 4 and the bending portion 7a of the bracket 7 in the X-axis direction. Therefore, as shown in FIG. 3, a case in which the battery pack 4 comes into contact with the brackets 7 can be reduced when the vehicle 2 suffers a side collision and the reinforcing member 6 is damaged.

In the joining structure 1 of the embodiment, the reinforcing member 6, the brackets 7, the center tunnel reinforcement 3b of the floor panel 3, and the fragile portion 8h of the joining member 8 are each configured to have a higher bending rigidity about the Y-axis in the stated order, but the order of the brackets 7 and the center tunnel reinforcement 3b of the floor panel 3 may be reversed.

Note that the joining structure 1 of the embodiment only needs to have a configuration in which at least the bending rigidity of the fragile portion 8h of the joining member 8 about the Y-axis is lower than the bending rigidity of the center tunnel reinforcement 3b in the floor panel 3 about the Y-axis.

When the floor panel 3 does not include the center tunnel reinforcement 3b, the center tunnel reinforcement 3b can be read as the center tunnel 3a in the description above.

In the joining structure 1 of the embodiment, configurations of the reinforcing member 6, the brackets 7, and the like are exemplifications, and a configuration in which the end portion on the X-axis+side of the battery pack 4 can be joined to the joining member 8 only needs to be provided. The configuration of the joining member 8 is also an exemplification, and the joining member 8 only needs to include at least the third portion 8f of the bending portion 8a and the fragile portion 8h.

The present disclosure is not limited to the embodiment described above and can be changed, as appropriate, without departing from the gist.

What is claimed is:

1. A joining structure of a battery pack, the battery pack being disposed on a lower side of a floor panel having a center tunnel that extends in a front-rear direction of a vehicle, the joining structure joining the battery pack to the floor panel, the joining structure comprising:
a bracket to which a side end portion on either left or right of the battery pack is joined; and
a joining member that joins an upper end portion of the bracket and the floor panel to each other, wherein the joining member includes:
an inclined portion that joins the bracket and the floor panel to each other and heads toward an upper side as an inner side of the vehicle is approached; and
a fragile portion that is disposed in a lower end portion of the inclined portion and has a rigidity about an axis that extends in the front-rear direction of the vehicle that is lower than a rigidity of the center tunnel about the axis that extends in the front-rear direction of the vehicle.

2. The joining structure of a battery pack according to claim 1, wherein a rigidity of the bracket about the axis that extends in the front-rear direction of the vehicle is higher than the rigidity of the fragile portion of the joining member about the axis that extends in the front-rear direction of the vehicle.

3. The joining structure of a battery pack according to claim 2, comprising a reinforcing member that joins the side end portion of the battery pack and the bracket to each other, wherein a rigidity of the reinforcing member about the axis that extends in the front-rear direction of the vehicle is higher than the rigidity of the bracket about the axis that extends in the front-rear direction of the vehicle and the rigidity of the center tunnel about the axis that extends in the front-rear direction of the vehicle.

4. The joining structure of a battery pack according to claim 3, wherein a gap portion for preventing contact between the battery pack and the bracket at a time of a side collision of the vehicle is provided between the battery pack and the bracket in a left-right direction of the vehicle.

5. The joining structure of a battery pack according to claim 3, wherein:
the rigidity of the fragile portion of the joining member about the axis that extends in the front-rear direction of the vehicle is lower than a rigidity of a center tunnel reinforcement provided in the center tunnel about the axis that extends in the front-rear direction of the vehicle; and
the rigidity about the axis that extends in the front-rear direction of the vehicle is higher in an order of the reinforcing member, the bracket, the center tunnel reinforcement, and the fragile portion of the joining member.
